(19) United States
(12) Patent Application Publication
(10) Pub. No.: US 2004/0057133 A1
(43) Pub. Date: Mar. 25, 2004

(54) Structural improvement of vehicular tail ground mirror

(76) Inventor: Hsu Ming Chen, Taoyuan (TW)

Correspondence Address: BRUCE H. TROXELL, Suite 1404, 5205 Leesburg Pike, Falls Church, VA, 22041, US

(21) Appl. No.: 10/270,623

(22) Filed: Oct. 16, 2002

(30) Foreign Application Priority Data
Sep. 20, 2002 (TW) 91214881

(51) Int. Cl. G02B 5/08

(52) U.S. Cl. 359/844; 359/872

(57) ABSTRACT

This invention relates to a structural improvement of a vehicular tail ground mirror mainly comprises an outer hood, a mirror body, a support bracket and a linkage system. Inside the outer hood, there is a mirror body. The outer hood has a front opening for installing the support bracket, two side plates and a front arch plate forming a recess to receive the mirror body. The side plates and a lower part of the mirror body are outwardly curved. The central pane of the mirror body is a flat surface to display the real space and distance. The curvature of the mirror pane intensifies the effect of the wide angular reflection and the frame mounted on the outer hood will focus the vision to provide a clean visibility within the range the mirror covers. This device renders the driver a greater safety when driving the car.

### FIELD OF THE INVENTION

This invention relates to a structural improvement of the vehicular tail ground mirror mounted on the rear windshield. The mirror body is protected in the outer hood to maintain the mirror in clean condition and to render a neat landscape the mirror reflects.

### BACKGROUND OF THE INVENTION

To give the driver a better vision in reverse driving, the manufacturers, even including the owners, are likely to equip the rear windshield of vans, coaches and buses of small or middle size with a tail ground mirror on the hanging shank. While the bus is running, the tail ground mirror vibrates vigorously. After years in operation, the preset reflection angle between the tail ground mirror and the hanging shank will be deteriorated to a great extent. It will no longer give the reflected vision of the landscape the mirror is designed to cover. In particular, in snowy or rainy days, the mirror becomes blurred, and lost its designed performance.

### SUMMARY OF THE INVENTION

The key object of this invention is to provide a tail ground mirror steadfastly fixed on the rear windshield. The outer hood is secured firmly in place to maintain the reflection angle always as accurate as it is first regulated to reduce the vibration derived from the driving to the minimum. Even in the snowy and rainy days, the outer hood keeps the snow and raindrop away from the mirror, so it always gives the driver a very clean vision behind the bus to ensure a safe reverse driving.

Another object of this invention is to provide a flat pane surface and the curvature under the mirror pane. The flat pane gives a real space and distance behind and the curvature of the mirror pane intensifies the effect of wide angle vision.

The structure and traits of the tail ground mirror of this invention are explained in great details with the aid of the embodiments as illustrated in the drawings.

### BRIEF DESCRIPTION OF THE DRAWINGS

FIG. 1 shows a stereo outlook of the tail ground mirror of this invention.

FIG. 2 shows a side view of the tail ground mirror of this invention.

FIG. 3 is a disassembly of the tail ground mirror of this invention.

FIG. 4 is a stereo outlook of the mirror body of the tail ground mirror of this invention.

FIG. 5 is a cross section of side view of the tail ground mirror of this invention.

FIG. 6 is a schematic diagram of operation the tail ground mirror of this invention.

FIG. 7 is a schematic diagram showing the motor driven automatic control system for the mirror body of the tail ground mirror of this invention.

FIG. 8 shows a third brake lamp of the tail ground mirror of this invention.

### DETAILED DESCRIPTION OF THE INVENTION

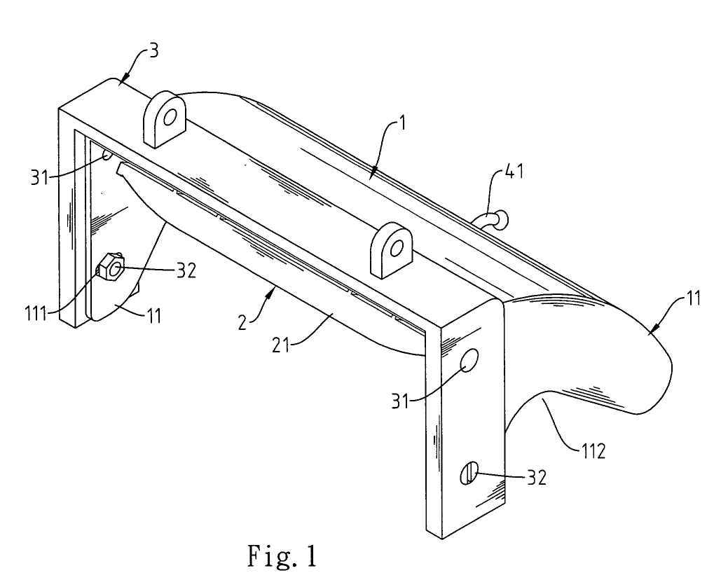

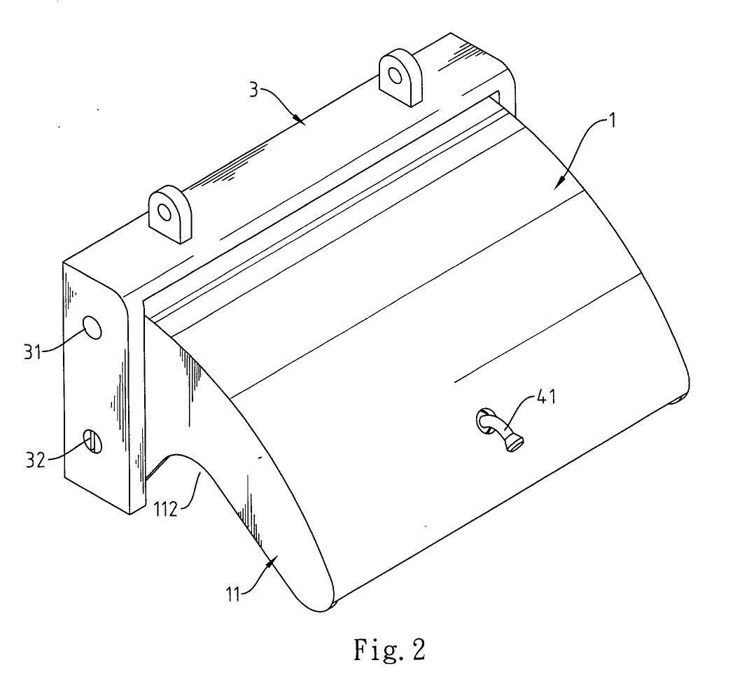

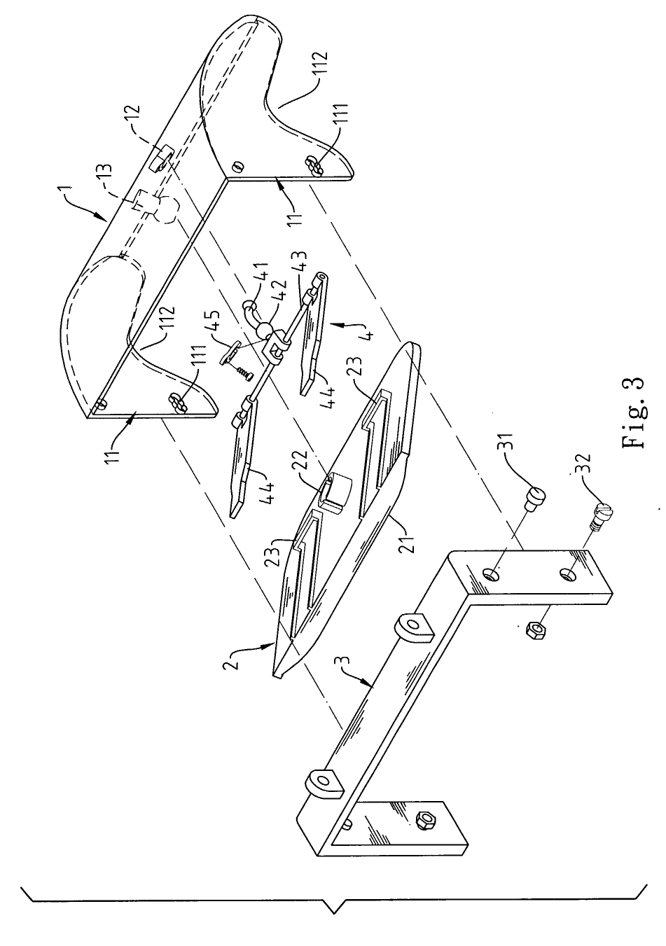

As shown in FIGS. 1 through 3, the vehicular tail ground mirror mainly comprises an outer hood 1, mirror body 2, a support bracket 3 and linkage system 4, wherein the support bracket 3 is glued or bolted to the rear windshield, or integrated on the bus body. The outer hood 1 contains inside the mirror body 2 and a front opening. The outer hood 1 is bolted on the support bracket 2 by means of a lock pin 31. The position between the outer hood 1 and the support bracket 3 can be adjusted by by fastening the arched adjusting slot 111 on the outer hood 1 to the bolt 32 on a side of the outer hood 1. By moving the outer hood 1 forward or rearward to ensure the best vision of the rear view from the vehicular tail ground mirror.

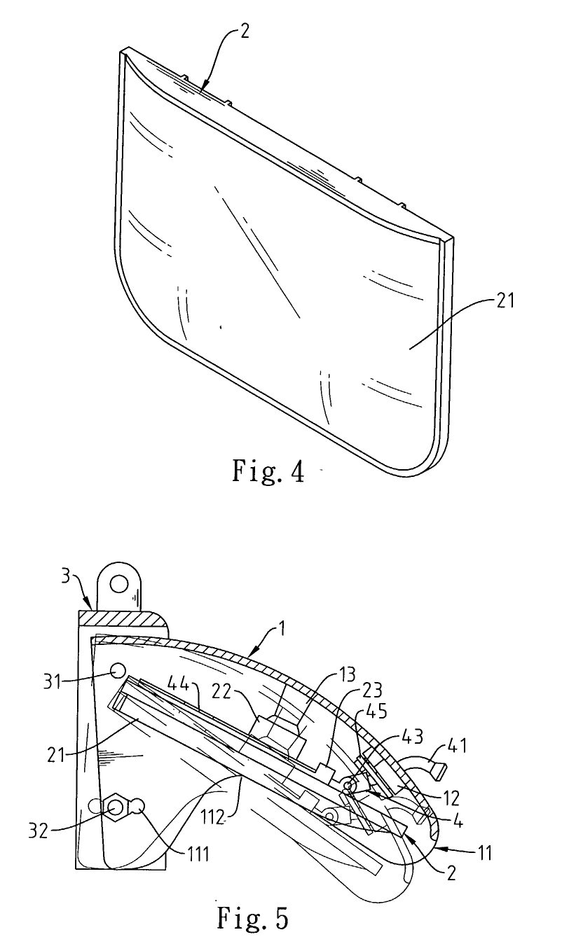

The side plate 11 on the outer hood 1 has a rearward curvature 112 to broaden the lighting range of the mirror instead. There are a fixing rack 12 and a projected knob 13 on the outer hood 11. There are two frames 23 and a pivot rack 22 disposed between two frames 23 on the back of the mirror body 2 which will be linked with the linkage system 4. Two side plates and the lower part of the mirror pane 21 are in curved form and the central mirror 2 is of a flat surface as shown in FIG. 4. While in reverse driving, the flat surface of the mirror 2 will render a real space and distance in the landscape behind and the curve below the pane will intensify the effect of wide angular vision.

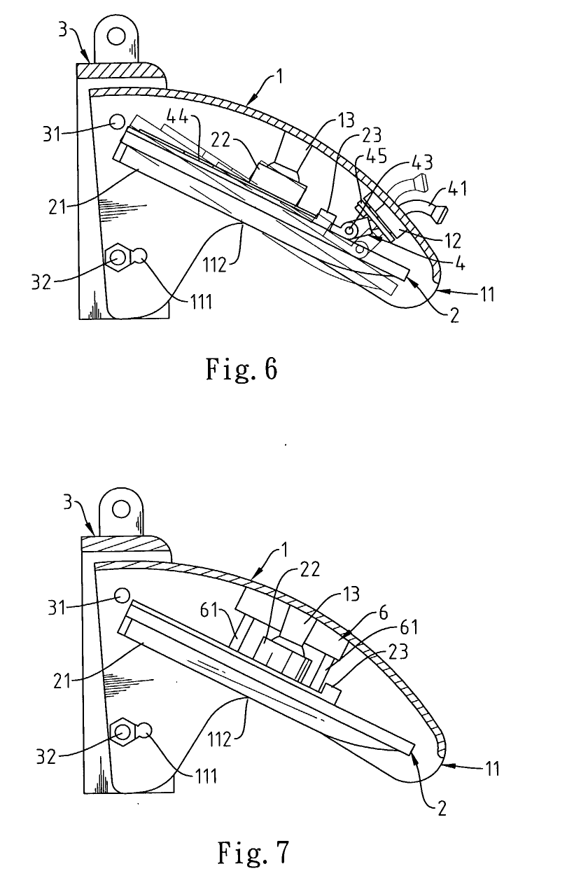

As shown in FIGS. 4 through 6, the linkage system constitutes a control rod 41, a rotor 42, a connecting rod 43, two movable arms 44 and fastening strap 45, where the control rod 41 penetrates out of and fastened to the fixing rack 12 on the outer hood 1.The control rod 41 has the rotor 42 at the lower end. The control rod 41, along with the rotor 42 and the fastening strap 45 is fastened to the fixing rack 12 on the outer hood 1, where the rotor 42 is permitted to rotate in the round groove in the fixing rack 12. When the control rod 41 is manipulated, it drives the rotor 42, the connecting rod 43 and the movable arms 44 which make an upward, downward, leftward and rightward adjustment on the mirror body 2 to gain the best reflected vision behind.

As shown in FIG. 7, a motor 6 is mounted on the mirror body 2 to manipulate movement of two shafts 61 for automatically adjusting the right angle of tail ground mirror body 2 the driver desires without handling operation.

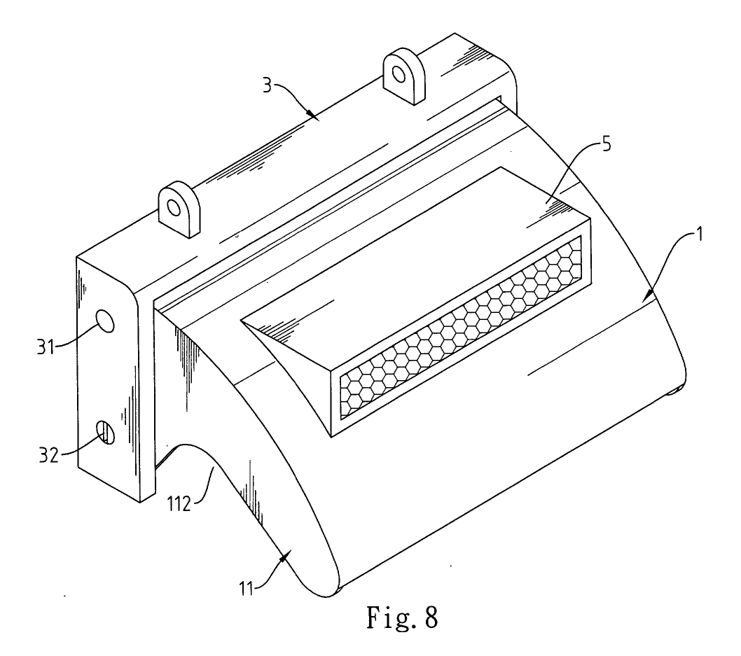

A third brake lamp 5 can be mounted on the outside of the outer hood 1 as shown in FIG. 8.

What is claimed is:

1. A structural improvement of a vehicular tail ground mirror, mainly comprising an outer hood, a mirror body installed inside of said outer hood, a support bracket disposed at a front opening of said outer hood and an adjusting slot for proper angular adjustment to gain clear rear vision while said vehicular tail ground mirror mounted on a rear windshield,
characterized in that:
said outer hood has two side plates and an arch plate forming a recess to receive a mirror body;
side plates and a lower part of said mirror body are outwardly curved, a central pane of said mirror body is a flat surface;
with said flat surface of said central mirror pane, real space and distance behind a bus can be displayed, and curvature of said mirror pane intensifies effects of wide angle vision.

2. The structural improvement of the vehicular tail ground mirror of claim 1, wherein said outer hood has a fixing rack and a projected knob, and on back of said mirror body furnishes two frames and a pivot rack in-between to be connected with a linkage system, said linkage system consists of a control rod, a rotor, a connecting rod, a fastening strap and two movable arms, wherein said control rod is fixed to said fixing rack on said outer hood with said fastening strap, and said control rod can be inset in a round groove of said fixing rack through a rotor fastened to said control rod, said control rod is extended to be connected to said connecting rod transversely, two ends of said connecting rod are connected to said moveable arms, said moveable arms can be placed on a frame of back of said mirror body, when said control rod is manipulated, said mirror body can be adjusted upward, downward, leftward or rightward to obtain best rear vision.

3. The structural improvement of the vehicular tail ground mirror of claim 1, wherein a third brake lamp is mounted on said vehicular tail ground mirror.

4. The structural improvement of the vehicular tail ground mirror of claim 1, wherein a motor is mounted on said mirror body to manipulate movement of two shafts for automatic adjustment of said mirror body.
